(19) United States
(12) Patent Application Publication
(10) Pub. No.: US 2003/0158806 A1
(43) Pub. Date: Aug. 21, 2003

(54) Automated ranked bid sales method and system

(76) Inventors: James P. Hanley, Woodbury, CT (US); Walter T. Van Wyck, Oxford, CT (US)

Correspondence Address: BUCKLEY, MASCHOFF, TALWALKAR, & ALLISON, 5 ELM STREET, NEW CANAAN, CT, 06840, US

(21) Appl. No.: 10/076,683

(22) Filed: Feb. 15, 2002

(51) Int. Cl. G06F 17/60

(52) U.S. Cl. 705/37

(57) ABSTRACT

The present invention includes a system and method for providing automatic ranked bid sales. A computerized bid paddle or other identifier is utilized to allow a bidder to place bids anonymous to other bidders. A relative ranking of placed bids is provided and associated with the bid paddle but an exact amount of a bid is not disclosed. Various tracking and communication is also provided between an auction provider and a bidder in order to emulate the role of a traditional auctioneer. Each identifier is unique to a particular bidder for a particular sale of an item to be auctioned. A description of the auctioned item to be sold is also transmitted and a plurality of bids for the item to be sold is received.

### FIELD

The present invention relates to a system and method for conducting an online auction. In particular, the present invention relates to a system and method for providing computerized anonymous bidding at an online auction with an indication of a ranking of a bid.

### BACKGROUND

Auctions pertain to the purchase or sale of real or personal property through a public bidding process. Traditionally, auctions consisted of the gathering together of interested parties, wherein the parties would form a crowd and make a succession of increasing bids for a particular piece of property being auctioned. Therefore it is known for an auctioneer to act as an agent for the seller and facilitate an auction by generally motivating potential buyers to make increasing bids. The enthusiasm of a crowd of bidders and the momentum sustained by the auctioneer is generally designed to secure a satisfactory price for the property being sold. Bidders are typically assigned a bidding paddle with a number or other indicator displayed on the paddle. The auctioneer refers to the paddle number during the bid, but not the bidder's identity. In addition, an auction crowd generally discloses who the interested parties are unless a bidder goes to the expense and inconvenience of providing a bidder's agent who actually stands in the crowd and thereby anonymously bids on behalf of the actual bidder for a piece of property. The momentum of the auction is carried until a highest final bid is accepted by the auctioneer.

A despondent bidding crowd can also play an integral part of an auction in that a despondent crowd generally has a dampening effect on offers being made. A lack of enthusiasm by other bidders can act as a warning to a potential bidder concerning a possible defect in the property being sold.

In addition, a traditional auction structure allows a bidder to know precisely what a competitive bid amount is and to offer a successive bid that is only incrementally higher than a previously highest bid instead of moving to a price approximately equal to a maximum amount that the bidder may be willing to ultimately bid.

A sealed bid auction accepts a secret bid that can keep the identity of a bidder and the amount that the bidder is bidding secret from other bidders. The sealed bid may forfeit the momentum of a live auction, but can also take advantage of the uncertainty surrounding who else may be bidding and how much they may bid. If an item being auctioned is important to a bidder, it is conducive for the bidder to bid a price that is close to, or at, the highest amount that the bidder is willing to spend for the auctioned item. Moreover, a sealed bid can keep the final price confidential if so desired.

Computer networks, and the Internet in particular, have created a resurgence in the use of auctions as a means of conducting commerce. Generally the Internet makes an auction available to a larger audience than a local auction can accommodate. In addition, the Internet can be useful in allowing a bidder to participate who may be otherwise constrained due to geographical limitations. Typically a picture and/or description of a piece of property is made available to potential bidders via a Website on the Internet. Based on the description, bidders can make a bid for the property. A cutoff date and time may end all bidding, in which case a bidder with the highest offer is awarded the item at the highest bid price. Alternatively, a first bidder to reach a threshold amount may be declared the winner. Payment for a winning bid can either be arranged between the two parties, or through an auction service conducting the auction.

Internet auctions have popularized various formats for auctions for almost any conceivable property. For example, Dutch auctions are offered on the Internet wherein a seller offers property at successively lower prices until one of his offers is accepted. Reverse auctions operate wherein several sellers compete to sell an equivalent product at successively lower prices. A Vickery auction awards the auctioned item to the highest bidder at the sum bid by the second highest bidder. Another variation allows a buyer to name a price the buyer is willing to pay for a product or service and various sellers can accept the offer. However, present forms of auctioning conducted on the Internet do not effectively incorporate the emotions of a bidding crowd, the actions of an auctioneer and the enthusiasm surrounding the bidding process and also maintain the uncertainty of not knowing who a bidder may be bidding against and an exact amount of a competitor's bid.

### SUMMARY

Accordingly, to alleviate problems inherent in the prior art, the present invention introduces systems and methods for a computerized bid paddle or other identifier, which allows a bidder to place bids anonymous to other bidders. A relative ranking of placed bids is provided and associated with the bid paddle but an exact amount of a bid is not disclosed. Various tracking and communication is also provided between an auction provider and a bidder in order to emulate the role of a traditional auctioneer.

A method is provided for an automated rank bid sale wherein unique identifiers are transmitted to a plurality of bidders. Each identifier may be unique to a particular bidder for a particular sale of an item to be auctioned. A description of the auctioned item to be sold is also transmitted and a plurality of bids for the item to be sold is received. Each bid is associated with one of the unique identifiers. The automated rank bid system ranks the unique identifiers associated with each bid received according to the amount of the bid associated with each unique identifier.

A bidder associated with a unique identifier can be logged in and the bidder can be associated with a network access device. The login can include receiving demographic data descriptive of the bidder. A visual indicator highlighting the unique identifier associated with the bidder can be transmitted to the network access device.

The unique identifier can include a paddle ID. The indication of ranked unique identifiers can include a tiered ranking of unique associated identifiers or a display ordering the unique identifiers according to the descending value of a most recent bid received that is associated with each unique identifier.

A communication relating to a particular sale can be generated and transmitted to bidders. The communication, such as a solicitation for a subsequent bid, can be customized for each bidder according to the bid ranking associated with each bidder.

Sale particulars can be recorded by a computerized system involved in the ranked bid sale. The sale particulars can include bidding patterns associated with a bidder, or other information. A payment relating to the sale of the auction item can also be arranged.

The present invention can also include a computerized system for providing a ranked bid sale. Other embodiments can include computer executable program code residing on a computer-readable medium or a computer signal for causing a computer to execute instructions to implement the current invention.

In another aspect, the present invention can include methods and systems for participating in a ranked bid sale. A participant can receive an anonymous bidder identifier unique for a particular sale of an auction item and a description of the auctioned item to be sold. A bid can be transmitted for the item to be sold, wherein the bid is associated with the anonymous bidder identifier and a ranked indication of whether the anonymous identifier is associated with a winning bid relative to other anonymous identifiers can be received.

The ranked indication can include multiple anonymous identifiers grouped in tiers, wherein each tier is indicative of a relative standing of a bid associated with each anonymous identifier or a graphical representation of the relative standing of the anonymous identifiers according to the bids associated with each anonymous identifier.

An electronic communication can also be received at a network access device associated with the anonymous bidder identifier. An additional bid responsive to the electronic communication can also be transmitted.

In another aspect, a ranked bid sale can include receiving an electronic communication indicating that the bid does not meet a minimum threshold bid amount.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of an ARB system according to an embodiment of the present invention.

FIG. 2 illustrates a network diagram of an embodiment of the present invention.

FIG. 3 illustrates a database according to the present invention.

FIG. 4 illustrates a flow chart of steps that can be taken by a computerized system to implement the present invention.

FIG. 5 illustrates a flow chart of steps that can be utilized to implement the present invention.

FIGS. 6 and 7 illustrate graphical user interfaces that can be utilized to interact with a computerized system implementing the present invention.

### DETAILED DESCRIPTION

Embodiments of the present invention are directed to a computerized automated ranked bid (ARB) sale system and method for providing for an online auction that includes a computerized bid paddle or other identifier, which allows a bidder to place bids anonymous to other bidders. The ARB method of bidding also allows for a price that is bid to be kept confidential, such that other bidders are not aware of the price of a bid, only a relative ranking of their bid. Anonymous and confidential bids facilitate a bidder making a bid that is more than just incrementally greater than a last highest bid, since the bidder does not know who they are bidding against, or how much the other bids are. Keeping the price of a bid confidential can also prevent an auction from becoming a de facto pricing standard since price can be kept confidential between the auction provider and the winning bidder. This can be especially important when the price of an auction item (e.g., a product or service) is substantial, as may be the case for commercial, institutional, or industrial items (e.g., trucks and forklifts).

In addition, the present invention includes an automated ranking of bids and a color highlight of a bid associated with a particular user logged in. Various tracking and communication is also provided between an auction provider and a bidder in order to emulate the role of a traditional auctioneer.

In this description, a sale can include an auction or other sales vehicle where ranked anonymous bids can facilitate an efficient transaction. Accordingly, a user can include a bidder or other interested party to a sale.

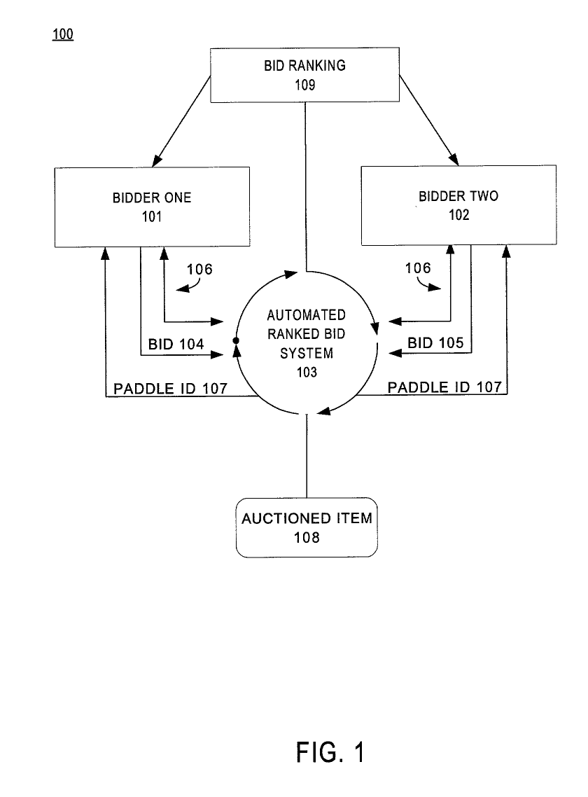

FIG. 1 is a block diagram of an ARB system 100 according to one embodiment of the present invention. A computerized ARB system 103 opens a communication channel 106 with a plurality of bidders 101-102. The ARB system 103 receives detailed information relating to the bidder 101-102 which can include the identification of the bidder 101-102, contact information including an e-mail address, credit and/or proposed payment information, description of a type of business involved, or other information.

The ARB system 103 can also provide a unique identifier to the bidder, such as a paddle ID 107. The paddle ID 107 must be unique to a particular sale such that two bidders cannot have the same identifier 107 in the same sale or auction. However, a particular paddle ID 107 may be utilized by the same bidder to participate in several auctions if permitted by the auction provider. In one embodiment, an auction can be specific to a particular auctioned item 108, in another embodiment, an auction can include multiple auctioned items 110 of similar description.

A bidder 101-102 submits a bid 104-105 to the ARB system 103. The received bid 104-105 is utilized to ascertain a bid ranking 109 according to the relative value of each bid 104-105 received.

Automated bid ranking 109 is provided according to the paddle ID associated with the bid 104-105 being ranked. For example, if a bidder 101-102 is assigned a paddle ID of White 6, a bid ranking 109 will identify the bid 104-105 and associate the bid with the paddle ID 107, but keep the bidder 101-102 anonymous. Therefore, to continue with the example at hand, the White 6 bid will be ranked relative to other bids, such as a bid from a paddle Red 2. The bid ranking 109 will display, or otherwise indicate, whether the White 6 bid 104-105 or the Red 2 bid 104-105 is in a senior position, and also whether the White 6 bid 104-105 or the Red 2 104-105 bid is a winning bid 104-105.

In an ARB system according to the present invention, the information displayed can include an indication of which paddle ID 107 or other identifier represents the winning bid, but no currency amount or other indicator of a bid amount is displayed. Ranking can include ordering multiple paddle IDs 107, each associated with a different bidder and therefore different bids. A paddle ID 107 associated with a highest bid 104-105 is displayed at one end of the ranking and other paddle IDs 107 are ordered according to diminishing bid 104-105 amounts.

In another embodiment, bid ranking 109 can include grouping bids in tiers, or other categorizations, that are indicative of how close a bidder 101-102 is to being a winning bid. For example, a bid ranking 109 may include multiple tiers, such as four tiers. A first tier may indicate that a bidder 104-105 has a winning bid. A second tier may indicate that a bid 104-105 is relatively close to a winning bid 104-105. Additional tiers would indicate that a bid 104-105 is progressively further from being the winning bid 104-105. Still other embodiments can include the use of a color coded scale, for example from red to blue indicating how close a bid may be.

In a similar fashion, if a bid 104-105 does not meet a threshold for a minimum bid 104-105, the ARB system 103 can communicate that the bid 104-105 is unacceptable. A threshold may include, for example, a price determined as a percentage of fair market value. In one embodiment a threshold can be adjusted according to an amount received in a sale for an aggregate of auction items to be sold, for example if 48 items included in a group or other lot of 50 items have received more than adequate sale prices, or if an amount x is required for the aggregate of the group of items, and x has been exceeded, the threshold may be lowered for any remaining items from the group still being sold.

In addition to the bid ranking 109, the ARB system 108 can communicate with a bidder 101-102 via the communication channel 106. Communication can relate to a previous or upcoming auction or to an auction underway that the bidder 101-102 is participating in. The communication channel 106 can emulate the function traditionally held by an auctioneer in a live auction. Accordingly, the communication can include promotional material relating to an item being auctioned 108, to the ranking of the bidders 101-102 bid, to potential financing available to a bidder 101102, or any other information that may facilitate the bidding process and lead to a higher bid 108. Methods of communication can include instant messaging, e-mail, a Website, pager, voice message, or other communication vehicle.

For example, during an auction, a bidder who has not placed a winning bid may be sent information advertising the auctioned item 108. This information can be customized according to the bidder 101-102 and/or the item auctioned 108, as well as the relative bidding position of the bidder 101-102 as reflected in the bid ranking. So, for example, if a piece of heavy equipment is being auctioned, bidder 101-102, such as an equipment dealer, who placed a non-winning bid 104-105 may receive a message communicating that the bidder 101-102 does not hold the winning bid 104-105. The bid 104-105 placed by the bidder 101-102 may actually the fourth place bid, for example. If desired the message can also include related information, such as a review of the auctioned item 108 by a ratings group or an industry publication. For example, an auction of a particular model truck may cause a message to be sent to bidder 101-102 or other potential auction participant, wherein the message may include an advertisement or related materials such as a review by a consumer group gave a favorable rating to the model truck being auctioned.

In another aspect of the present invention, the provider of an ARB system 103 and ranked bidding auction can use a communication link 106 to convey details relating to an auction event that will be hosted by the provider. The event can include special offerings or promotional incentives to participate. In addition, details can include the conditions under which an auctioned item 108 is to be conveyed, such as, “as is, where is”, freight on board buyer, warranted, insured, or other conditions of sale.

A communication link 106 can also be utilized to gather important data relating to the bidder 101-102. For example, a bidder 101-102 can be queried concerning a type of auction item the bidder 101-102 is most interested in, a geographic area of the bidder 101-102, an industry the bidder 101-102 is involved in, patterns of bidding, patterns to purchasing, or any other information relating to the bidder 101-102.

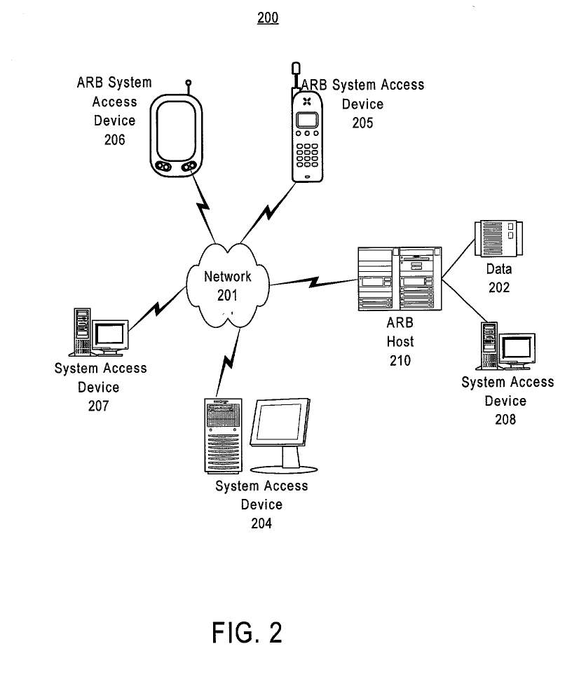

Referring now to FIG. 2, a network diagram illustrating one embodiment of the present invention is shown. An automated ARB system 200 can include an ARB host 210 accessible via a distributed network 201 such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network (e.g., in accordance with an 802.11 standard), and/or an Internet Protocol (IP) network such as the Internet, an intranet, or an extranet.

The ARB host 210 can include a computerized server or other automated information sharing device. A client, or other party interested in ARB content can use a computerized system or network access device 204-208 to receive, input, transmit or view information processed in the ARB host 210. A protocol, such as the transmission control protocol internet protocol TCP/IP can be utilized to provide consistency and reliability.

Each of the network access devices can include a processor, memory and a user input device, such as a keyboard and/or mouse, and a user output device, such as a display screen and/or printer. The network access devices 204-208 can communicate with the ARB host 210 to access data stored in databases 202 at the ARB host 210. The network access device 204-208 may interact with the ARB host 210 as if the host was a single entity in the network 201. However, the ARB host 210 may include multiple processing and database sub-systems, such as cooperative or redundant processing and/or database servers, which can be geographically dispersed throughout the network 201. In some implementations, groups of network access devices 204-208 may communicate with ARB host 210 through a local area network. Similarly, although a single distributed network host 101 and event calendar 104 is shown in FIG. 1, any number of event builders 101, event calendars 104, or other element of the invention may be included in the ARB system 100 according to embodiments of the present invention.

The ARB host 210 includes one or more databases 202 storing data relating to ARB content processing. The ARB host 210 may interact with and/or gather data from a user or other party interested in ARB content or any other person who is operating a network access device 204-208.

The ARB system 103 may comprise, for example, a Web server. A network access device 204-208 may be associated with, for example: a Personal Computer (PC) 204 207-208, a portable computing device such as a Personal Digital Assistant (PDA) 206, a wired or wireless telephone 205, or any other appropriate storage and/or communication device.

Typically a user will access the ARB host 210 using client software executed at a network access device 204-208. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the ARB host 210 to the client computer and executed at the client computer as part of the ARB system 103 software. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

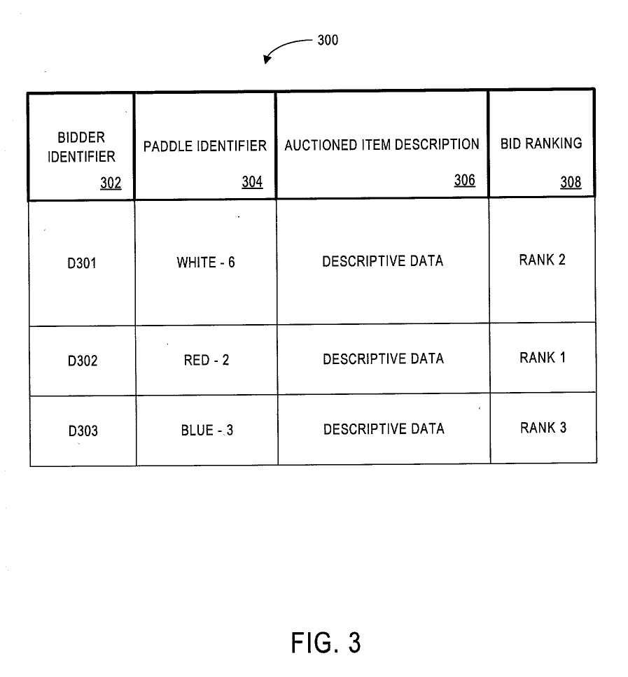

Referring now to FIG. 3, a table represents an ARB related database 300 that may be stored at the ARB host 210 and data 202 according to an embodiment of the present invention. The table includes entries identifying a bidder 302 that may participate in an auction via the ARB system 103. The table also defines fields 304, 306, 308 associated with each of the entries in the bidder identifier field 302. The fields can specify, for example: a paddle ID 304, a auctioned item description 306 and bid ranking 308. The information in the ARB related database 300 may be created and updated based on information received from a bidder 101-102, an auction provider, an auctioned item 108 appraiser or others.

The paddle ID 304 may be, for example, an alphanumeric code associated with a bidder 101-102. The auctioned item description 306 may describe an item currently being auctioned or scheduled to be auctioned at some specified date. According to one embodiment, the auctioned item description 306 can include text, graphical, and/or audio information that may be transmitted to an ARB access device 204-208 (e.g., to provide the description of the auctioned item 108 to the ARB access device 204-208 being utilized by a bidder 101-102 or other interested party.

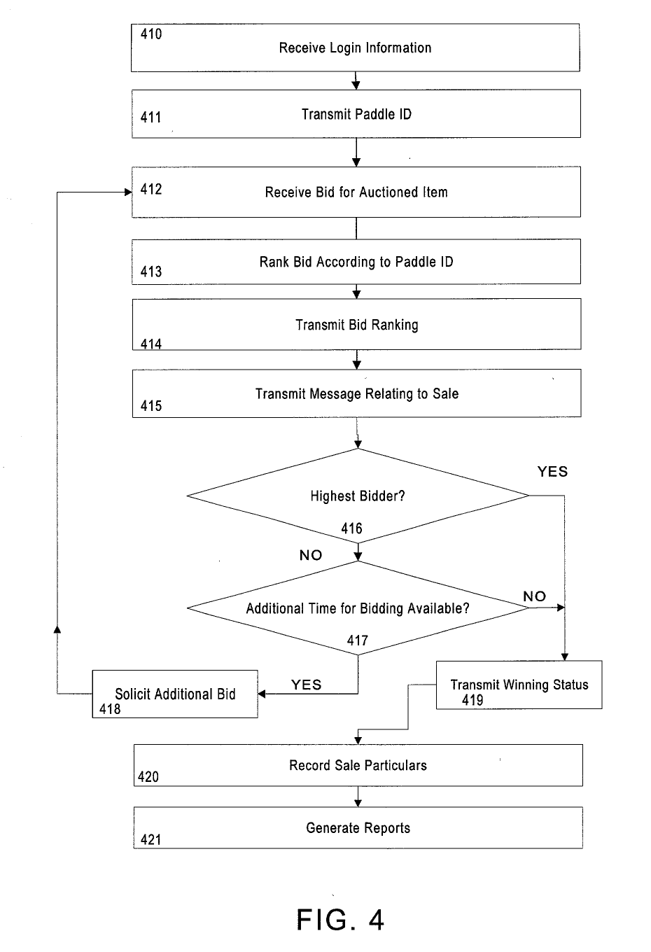

FIG. 4 illustrates a flow chart of steps that can be taken in practicing the present invention. The flow charts described herein do not imply a fixed order to the steps, and embodiments of the present invention may be practiced in any order that is practicable.

An ARB system 100 according to the present invention can receive login information from a bidder 410. Typically, login can be accomplished by establishing a connection with the ARB host 210 via a network access device 204-208. Receiving the login information 410 can be accomplished, for example, by receiving a request from a bidder 101-102 to participate in an auction for a particular item 108 to be auctioned. Information can be keyed in, such as into an online form or other GUI, or received electronically via an electronic feed, e-mail message, or other form of communication.

The ARB system 100 can respond to the login information by transmitting paddle ID 107 that will associated with the bidder 101-102 for a predetermined session 411. The predetermined session can include, for example, for the duration of an auction for a specified item 108, for a specific duration, such as for a calendar day, until a predetermined lot of similar goods has been auctioned, or any specified term. In one embodiment, a paddle ID 107 can be assigned randomly from a pool of acceptable paddle IDs 107. In another embodiment, a bidder can be allowed to specify a paddle ID 107. Similar to the establishment of login information, an interface can be associated with conveying an ARB paddle ID 107 such that related information can be keyed in, such as into an online form or other GUI, or received electronically via an electronic feed, e-mail message, or other form of communication.

The ARB host 210 can receive a bid 412 from a bidder 101-102 associated with a paddle ID 107, wherein the bid will be for a specific auctioned item 108. The ARB host 210 can rank the bid according to paddle ID 413 and transmit the bid ranking to the network access device associated with the bidder 414. As discussed previously, the bid ranking can include a relative standing of the bid received, as the bid compares to other bids received for the same auctioned item or it can simply indicate whether the bid is the winning bid or not. Other embodiments include some indication of how close the bid is to a winning the current winning bid, such as, for example, a tiered approach, a color scheme, or other indicators that can provide information without indicating an exact bid amount. In another aspect, if a bid is below a predetermined threshold, such as a percentage of fair market value for the item auctioned, or a predetermined currency value, bid ranking can respond with a message indicating that the id will not be ranked until it includes an amount greater than the minimum threshold.

Similarly, the ARB host 210 or a user acting to facilitate the auctions can also transmit a message relating to other aspects of the sale 414. In one embodiment, the message relating to the sale can simulate the function traditionally provided by an auctioneer, including talking favorably about the item being auctioned, presenting relevant data and the like. Another embodiment can include transmitting a message including information relating to an auctioned item. Still another embodiment can include transmitting a message that includes financing options that would be made available to a winning bidder, wherein the financing may allow a bidder to make a higher bid.

The ARB host 210 can also determine if a bidder 101-102 has submitted the highest bid 104-105 and thus become the highest bidder 416. If the bidder 101-102 is the highest bidder, the ARB host 210 can transmit a message indicating the winning status 419. If a bidder 101-102 is determined to not be the highest bidder, the ARB host 210 can determine if there is additional time left to bid 417 and if there is time available, the ARB host 210 can solicit an additional bid 418 from the bidder 101-102.

The ARB host 210 can also record any particulars relating to the ARB sale 420 and generate reports and/or analysis concerning the ARB sale 421.

Typically, any analysis or reporting can be displayed via a GUI during an online session, however, it can also be generated and distributed electronically, such as through e-mail or instant messaging. In addition, the reports can be available from the ARB host server 210 upon request.

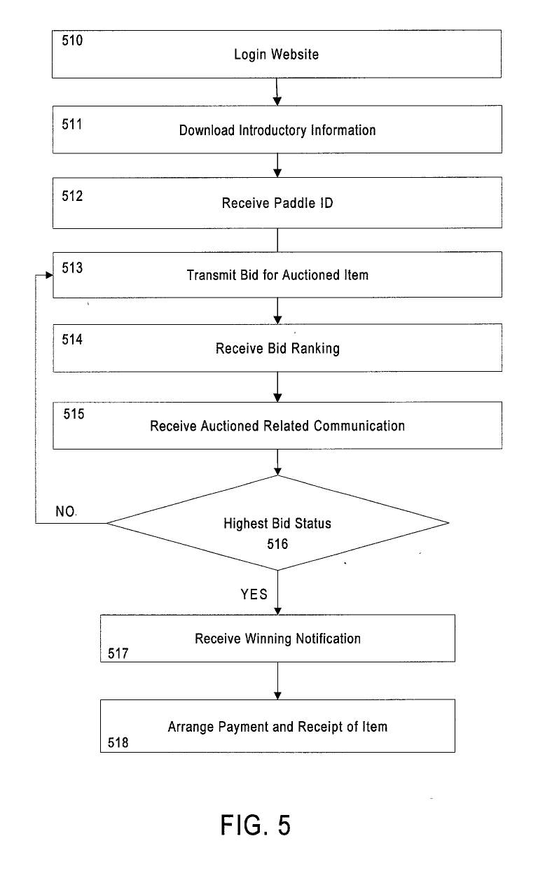

Referring now to FIG. 5, a flowchart is illustrated indicating steps that a bidder or other users may take in implementing the present invention. The bidder 101-102 can perform a login procedure at a specified website related to an ARB content server 210 by inputting details relating to an auction and associate a bidder 101-102 with a network access device 510. Typically these details may include identification of the bidder and other pertinent information, such as credit or payment information. Association with a network access device 204-208 can include linking the bidder 101-102 with a network address such as a TCP/IP address assigned to the network access device. Login can also require that a user agree to rules governing an auction and payment for items for which the user places the winning bid.

The user can download introductory information 511 via the network access device including, if appropriate, a program which may facilitate the bidding process. The user can also receive a paddle ID 512 via a download to the network access device 204-208 such that the user can transmit a bid for an auctioned item 513 and receive a bid ranking 514. The user can also receive an auction related communication 515. If the user has placed a highest bid 516, the user can receive a notification that the user is winning 517 or has won the auction. Arrangements can also be made online for payment related to the auction and receipt of the auctioned item 518.

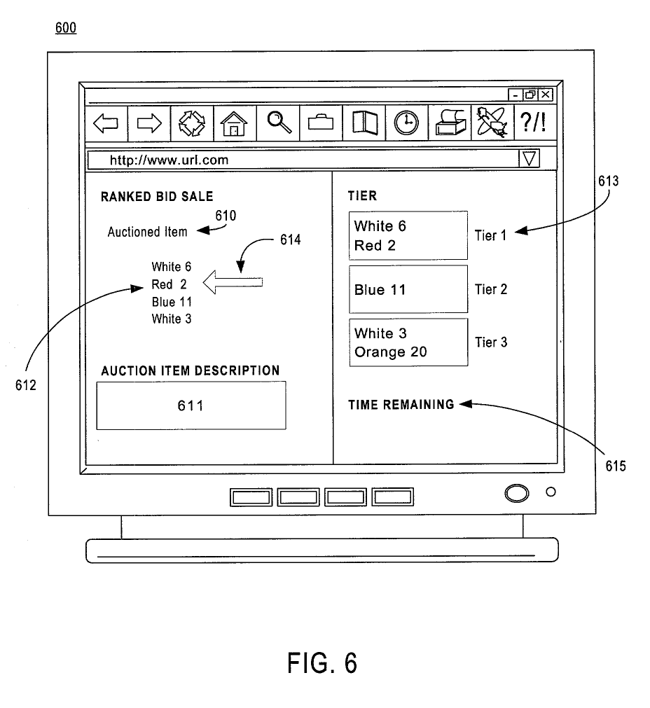

Referring now to FIG. 6, an exemplary GUI 600 for interacting with an ARB content server 210 is illustrated. The GUI 600 can include an area indicating the auctioned item 610 and well as an area containing a description of the auctioned item. The description area 611 can include written or pictorial information, such as an image of an item to be auctioned.

A bid ranking area 612 can display the paddle ID's 107 in ranked order so that a bidder can determine the relative ranking of their bid. In addition, a visual indicator 614 such as an arrow can be utilized to emphasize a user's paddle ID 107 and relative ranking. Another tiered indicator 613 can also be utilized to provide slightly more detailed indication of relative placement of a bid associated with a paddle ID 107.

Another portion of the GULI 600 can include an indicator of the time remaining in a ranked bid sale 615.

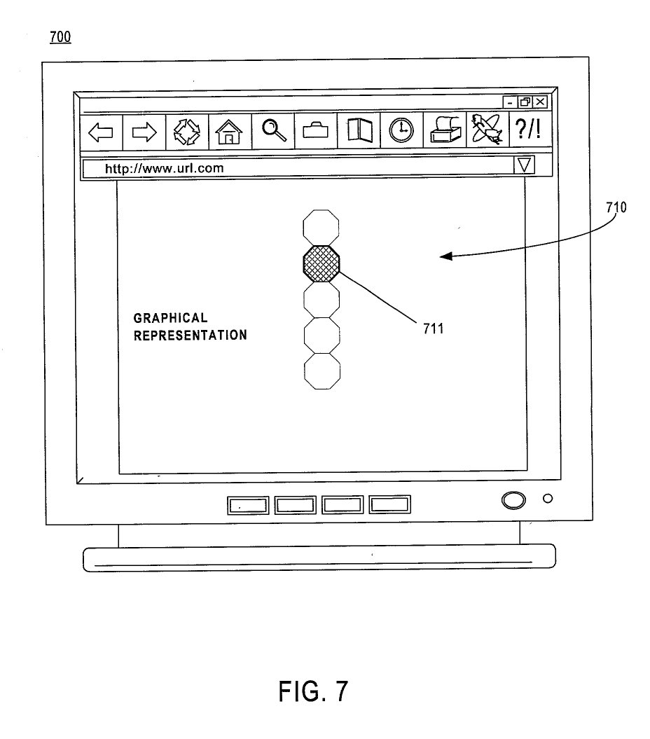

Referring now to FIG. 7, another embodiment of the present invention can include a GUI 700 with a graphical representation of the relative ranking of a bid 710. The graphical representation can include a geometric FIG. 711 associated with each bid, or some number of the topmost bids. The geometric figure associated with a bidder logged in can be highlighted, such as with a color or bold outline 711. As with other portions of the GUI's discussed, the graphical representation 710 can be placed on a dedicated GUI or be incorporated into a GUI with other features.

The foregoing illustrates various embodiments of the present invention. These do not constitute a definition of all possible embodiments, and those skilled in the art will understand that the present invention is applicable to many other embodiments. Further, although the foregoing embodiments are briefly described for clarity, those skilled in the art will understand how to make any changes, if necessary, to the above-described apparatus and methods to accommodate these and other embodiments and applications. Accordingly, other embodiments are within the scope of the following claims. For example, the present invention may be used to facilitate procurement of an item. In this case, unique identifiers may be associated with potential sellers (e.g., as opposed to potential purchasers) and ranked according to associated bid amounts.

What is claimed is:

1. A method of providing an automated rank bid sale, the method comprising:
transmitting unique identifiers to a plurality of bidders, wherein each identifier is unique to a particular bidder for a particular sale of an auction item;
transmitting a description of the auctioned item to be sold;
receiving a plurality of bids for the item to be sold, wherein each bid is associated with a unique identifier;
ranking the unique identifiers associated with each bid received according to the amount of the associated bid; and
transmitting an indication of the ranked unique identifiers.

2. The method for an automated rank bid sale of claim 1 wherein the unique identifier comprises a paddle ID.

3. The method for an automated rank bid sale of claim 1 wherein the indication of ranked unique identifiers comprises a tiered ranking.

4. The method for an automated rank bid sale of claim 1 wherein an indication of ranked unique identifiers comprises a display ordering the unique identifiers according to the descending value of a most recent bid received that is associated with each unique identifier.

5 The method for an automated rank bid sale of claim 1 wherein the bidder associated with the unique identifier is kept anonymous to other bidders.

6. The method for an automated rank bid sale of claim 1 additionally comprising the steps of:
logging in a bidder associated with a unique identifier and additionally associating the bidder with a network access device; and
transmitting to the network access device a visual indicator highlighting the unique identifier associated with the bidder.

7. The method for an automated rank bid sale of claim 6 wherein the login comprises receiving demographic data descriptive of the bidder.

8. The method for an automated rank bid sale of claim 1 additionally comprising the steps of:
generating a communication relating to a particular sale; and
transmitting the communication to the plurality of bidders.

9. The method for an automated rank bid sale of claim 8 wherein the communication is customized for each bidder according to the bid ranking associated with each bidder.

10. The method for an automated rank bid sale of claim 9 wherein the communication comprises a solicitation for a subsequent bid.

11. The method for an automated rank bid sale of claim 1 additionally comprising the step of recording sale particulars.

12. The method for an automated rank bid sale of claim 11 wherein the sale particulars recorded comprise bidding patterns associated with a bidder.

13. The method for an automated rank bid sale of claim 1 additionally comprising the step of arranging for payment relating to the sale of the auction item.

14. The method for an automated rank bid sale of claim 1, wherein the auction item comprises at least one of: (i) a product, (ii) a service, (iii) a commercial item, (iv) an institutional item, and (v) a industrial item.

15. The method for an automated rank bid sale of claim 1, further comprising:
determining that the auction item will be sold to a winning bidder; and
arranging for the winning bidder to provide an online payment for the auction item.

16. A computerized system for providing an automated rank bid sale over a distributed network, the system comprising:
a computer server accessible with a network access device via a communications network; and
executable software stored on the server and executable on demand, the software operative with the server to cause the system to:
transmit unique identifiers to a plurality of bidders, wherein each identifier is unique to a particular bidder for a particular sale of an auction item;
transmit a description of the auctioned item to be sold;
receive a plurality of bids for the item to be sold, wherein each bid is associated with a unique identifier;
rank the unique identifiers associated with each bid received according to the amount of the associated bid; and
transmit an indication of the ranked unique identifiers.

17. Computer executable program code residing on a computer-readable medium, the program code comprising instructions for causing the computer to:
transmit unique identifiers to a plurality of bidders, wherein each identifier is unique to a particular bidder for a particular sale of an auction item;
transmit a description of the auctioned item to be sold;
receive a plurality of bids for the item to be sold, wherein each bid is associated with a unique identifier;
rank the unique identifiers associated with each bid received according to the amount of the associated bid; and
transmit an indication of the ranked unique identifiers.

18. A computer data signal embodied in a digital data stream comprising data relating to auctions, wherein the computer data signal is generated by a method comprising the steps of:
transmitting unique identifiers to a plurality of bidders, wherein each identifier is unique to a particular bidder for a particular sale of an auction item;
transmitting a description of the auctioned item to be sold;
receiving a plurality of bids for the item to be sold, wherein each bid is associated with a unique identifier;
ranking the unique identifiers associated with each bid received according to the amount of the associated bid; and
transmitting an indication of the ranked unique identifiers.

19. A computer implemented method for participating in a ranked bid sale, the method comprising:
receiving an anonymous bidder identifier unique for a particular sale of an auction item;
receiving a description of the auctioned item to be sold;
transmitting a bid for the item to be sold, wherein the bid is associated with the anonymous bidder identifier; and
receiving a ranked indication of whether the anonymous identifier is associated with a winning bid relative to other anonymous identifiers.

20. The computer implemented method for participating in a ranked bid sale of claim 19 additionally comprising the steps of:
receiving an electronic communication at a network access device associated with the anonymous bidder identifier; and
transmitting an additional bid responsive to the electronic communication.

21. The computer implemented method for participating in a ranked bid sale of claim 19 additionally comprising the step of receiving an electronic communication indicating that the bid does not meet a minimum threshold bid amount.

22. The computer implemented method for participating in a ranked bid sale of claim 19 wherein the ranked indication comprises multiple anonymous identifiers grouped in tiers, wherein each tier is indicative of a relative standing of a bid associated with each anonymous identifier.

23. The computer implemented method for participating in a ranked bid sale of claim 19 wherein the ranked indication comprises a graphical representation of the relative standing of the anonymous identifiers according to the bids associated with each anonymous identifier.
